(19) United States
(12) Patent Application Publication
(10) Pub. No.: US 2007/0023553 A1
(43) Pub. Date: Feb. 1, 2007

(54) Top loading pepper mill filler

(76) Inventor: Corene Casselle, Burr Ridge, IL (US)

Correspondence Address: Mark E. Wiemelt, Esq., Ste. 3300, 10 S. LaSalle St., Chicago, IL, 60603, US

(21) Appl. No.: 11/194,887

(22) Filed: Aug. 1, 2005

(51) Int. Cl. A47J 42/00

(52) U.S. Cl. 241/169.1

(57) ABSTRACT

The present invention is a device which interfaces with a pepper mill and facilitates the transfer of peppercorns into the interior of the pepper mill. The pepper mill filler is primarily designed to work with a type of pepper mill which contains a removable top component secured in place by a locking nut screwed to a threaded shaft. When the top component is removed, the threaded shaft remains exposed. The pepper mill filler is a generally hemispherical bowl which is wide at the apex and narrower at the base. The base contains an outlet in the center which is wide enough to fit over the threaded shaft with ample room left over for whole peppercorns to fall through. The pepper mill filler is placed over the threaded shaft and rests on top of the peppermill. Peppercorns are poured through the wide opening of the dispenser and are guided to the interior of the pepper mill. When the pepper mill is fill, the dispenser is removed and the top component of the pepper mill is replaced and secured with the locking nut.

### BACKGROUND OF THE INVENTION

1. Field of the Invention

The present invention relates to devices which guide the transfer of flowable materials from one container to another, and, more particularly, relates to a novel and improved form of dispenser spout for the transfer of peppercorns to a pepper mill.

2. The Prior Art

Pepper mills typically contain an interior space holding whole peppercorns which are forced into a grinding area where the peppercorns are ground into a powder and dispensed as seasoning. Many pepper mills contain a removable top component which allows access to the interior for refilling with peppercorns as the need arises. However, the opening created by the removal of the top component is often relatively narrow, and the dispensing of peppercorns into the interior chamber can be both messy and cumbersome. In many cases, more peppercorns miss the opening and are spilled than are successfully taken in through the opening.

There is a need in the art for a device which aids in the dispensing of peppercorns into a pepper mill by providing a relatively wide target which channels the peppercorns into the interior of the pepper mill.

### SUMMARY OF THE INVENTION

The present invention advantageously overcomes the limitations in the conventional art and prior solutions. In view of the foregoing disadvantages inherent in the known types of pepper mills now present in the prior art, the present invention provides a new pepper mill filler.

The general purpose of the present invention, which will be described subsequently in greater detail, is to provide a new pepper mill filler which has many of the advantages of the prior art mentioned heretofore and many novel features that result in a new pepper mill filler which is not anticipated, rendered obvious, suggested, or even implied by any of the prior art devices, either alone or in any combination thereof. To attain this, the present invention generally comprises a device which interfaces with a pepper mill and facilitates the transfer of peppercorns into the interior of the pepper mill. The pepper mill filler is primarily designed to work with a type of pepper mill which contains a removable top component secured in place by a locking nut screwed to a threaded shaft. When the top component is removed, the threaded shaft remains exposed.

In its preferred embodiment, the peppercorn filler is a generally hemispherical bowl-shaped member which is relatively wide at the apex and narrower at the base. The base contains an outlet in the center which is wide enough to fit over the threaded shaft with ample room left over for whole peppercorns to fall through. The peppercorn filler is placed over the threaded shaft and rests on top of the peppermill. Peppercorns are poured through the wide opening of the dispenser and are guided to the interior of the pepper mill. When the pepper mill is full, the pepper mill filler is removed and the top component of the pepper mill is replaced and secured with the locking nut.

While the invention is primarily contemplated for use in facilitating the transfer of peppercorns into a pepper mill, the device is also suitable for the transfer of other condiments or seasonings into similar receptacles.

There has thus been outlined, rather broadly, the more important features of the present invention so that the detailed description of the preferred embodiment that follows may be better understood, and so that the present contribution to the art may be better appreciated. There are additional features of the present invention that will be described hereinafter in the detailed description of the preferred embodiment and which will form the subject matter of the claims appended hereto.

In this respect, before explaining at least one embodiment of the present invention in detail, it is to be understood that the present invention is not limited in its application to the details of construction and to the arrangements of the components set forth in the following description or illustrated in the drawings. The present invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the present invention in any way.

These together with other objects of the present invention, along with the various features of novelty which characterize the present invention, are pointed out with particularity in the claims annexed to and forming a part of this disclosure. For a better understanding of the present invention, its operating advantages and the specific objects attained by its uses, reference should be had to the accompanying drawings and descriptive matter in which there is illustrated a preferred embodiment of the present invention.

It is an object of this invention to provide a device which makes it easier to load peppercorns into a pepper mill.

It is an object of this invention to provide a device which is simple and easy to use.

It is a further object of this invention to provide a device which is inexpensive to manufacture and can be marketed at a low cost.

Further objects and advantages of the present invention will become apparent to those skilled in the art to which the invention relates, from the following embodiments described with reference to the accompanying drawings, the specification and claims.

### BRIEF DESCRIPTION OF THE DRAWINGS

The foregoing and other additional objects of the present invention will be readily appreciated by those skilled in the art upon gaining an understanding of the preferred embodiment as described in the following detailed description and shown in the accompanying drawings in which:

FIG. 1 is a top perspective view of the pepper mill filler

FIG. 2 is a side elevational view of the pepper mill filler

FIG. 3 is a top elevational view of the pepper mill filler

FIG. 4 is a side elevational view of a type of pepper mill with which the pepper mill filler is primarily designed to work

FIG. 5 is a side elevational view of the pepper mill filler positioned on top of a pepper mill

FIG. 6 is a top perspective view of the pepper mill filler positioned on top of a pepper mill

### DETAILED DESCRIPTION OF THE PREFERRED EMBODIMENT

While this present invention is susceptible of embodiments in many different forms, there are shown in the drawings and will be described in detail herein, a preferred embodiment, with like parts designated by like reference numerals and with the understanding that the present disclosure is to be considered as an exemplification of the principles of the present invention, and is not intended to limit the claims to the illustrated preferred embodiment.

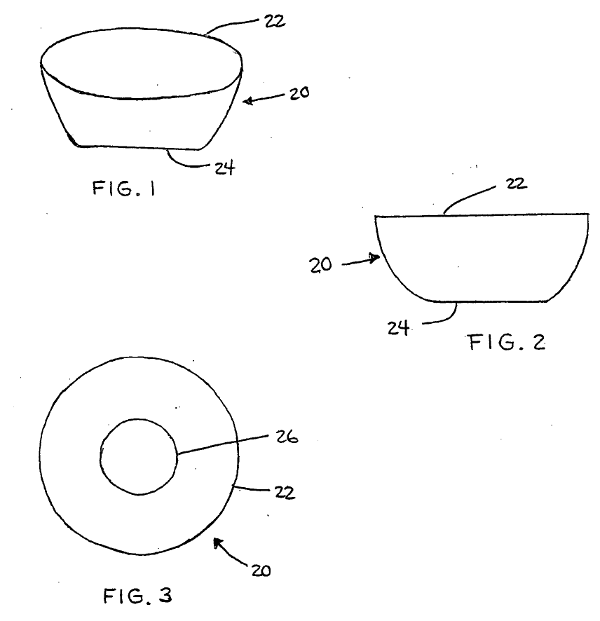

Referring now to FIGS. 1 and 2, the generally hemispherical shape of the pepper mill filler 20 is shown, and the pepper mill filler 20 is seen to be wider at its apex 22 than at its base 24. The relatively wide diameter of the apex 22 facilitates the pouring of whole peppercorns into the pepper mill filler 20 without spillage or mess.

FIG. 3 is a top elevational view of the pepper mill filler 20 and illustrates the outlet 26 in the center of the pepper mill filler 20 which provides ample room for peppercorns to fall through.

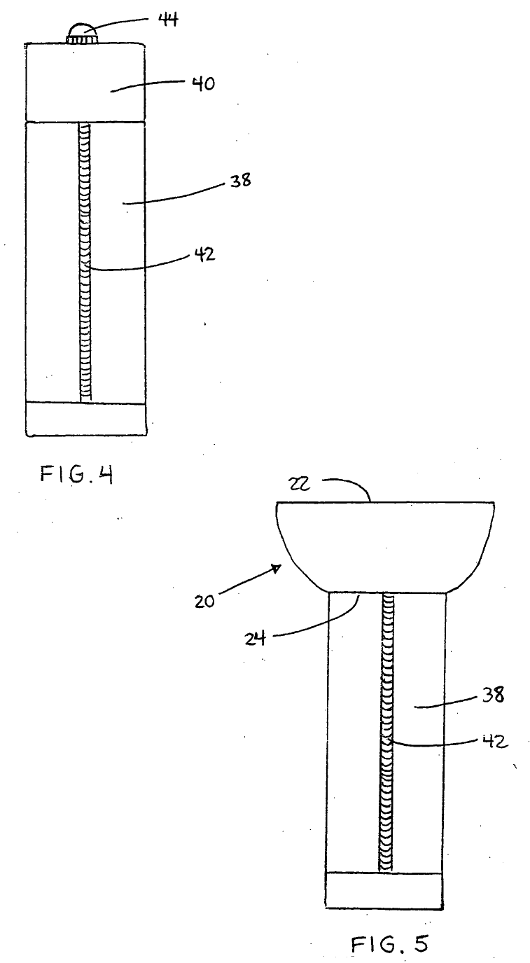

FIG. 4 shows a pepper mill 38 of the type with which the pepper mill filler 20 is primarily designed to work. The pepper mill 38 contains a removable top component 40 which is held securely in place by means of a locking nut 44 fastened to a threaded shaft 42 when the pepper mill 38 is dispensing ground pepper. When it becomes necessary to refill the pepper mill 38 with peppercorns, the locking nut 44 is unscrewed from the threaded shaft 42 and the top component 40 is removed.

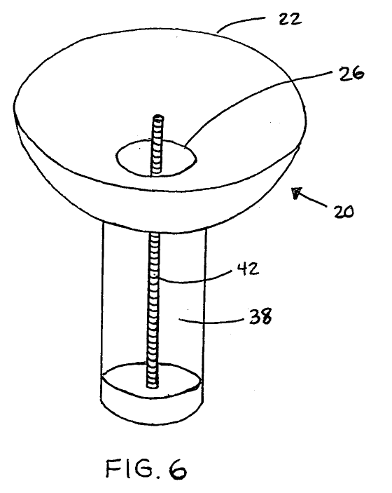

Referring now to FIGS. 5 and 6, the pepper mill filler 20 is positioned on top of a pepper mill 38 from which the top component 40 has been removed. The threaded shaft 42 protrudes through the outlet 26 of the pepper mill filler 20 leaving ample room for the peppercorns to fall through the outlet 26 into the interior of the pepper mill 38. The pepper mill filler 20 is not attached or threaded to the threaded shaft 42. Rather, the pepper mill filler 20 simply rests on top of the pepper mill 38. The, concave shape of the pepper mill filler 20 directs the flow of peppercorns to the outlet 26 where they fall into the interior of the pepper mill 38.

The pepper mill filler 20 is primarily designed to facilitate the transfer of peppercorns into a pepper mill, but the device is also suitable for the transfer of other condiments or seasonings into similar types of receptacles.

While the invention has been described in connection with a preferred embodiment, it will be understood that it is not intended that the invention be limited to that embodiment. On the contrary, it is intended to cover all alternatives, modifications and equivalents as may be included within the spirit and scope of the invention as disclosed.

As to the manner of usage and operation of the present invention, the same should be apparent from the above disclosure, and accordingly no further discussion relevant to the manner of usage and operation of the present invention shall be provided.

With respect to the above description then, it is to be realized that the optimum dimensional relationships for the parts of the present invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered illustrative of only the principles of the present invention. Further, since numerous modifications and changes will readily occur to those skilled in the art, it is not desired to limit the claims to the exact construction and operation shown and described, and accordingly, all suitable modifications and equivalents may be resorted to, falling within the scope of the claims.

1. A device used to facilitate the dispensing of condiments into a condiment dispenser: comprising:
a generally cylindrical member containing an apex and a base;
the member being wider at its apex than at its base;
the base containing an outlet of sufficient width to allow flowable materials to fall therethrough.

2. A device used to dispense peppercorns into a pepper mill, comprising:
a generally cylindrical member containing an apex and a base;
the member being wider at its apex than at its base;
the base containing an outlet of sufficient width to allow flowable materials to fall therethrough

3. The device of claim 2, wherein the pepper mill contains a removable top component, a threaded shaft, and a locking nut.

4. A device used to dispense peppercorns into a pepper mill, comprising:
a hemispherical bowl containing an apex and a base;
the hemispherical bowl being wider at its apex than at its base;
the base containing an outlet of sufficient width to allow flowable materials to fall therethrough.

5. The device of claim 4, wherein said pepper mill contains a removable top component, a threaded shaft and a locking nut.
